(19) United States
(12) Patent Application Publication
(10) Pub. No.: US 2018/0032617 A1
(43) Pub. Date: Feb. 1, 2018

(54) METHODS AND SYSTEMS FOR RETRIEVING DATA THROUGH BOTH AN APPLICATION SERVER AND A PORTAL SERVER

(71) Applicant: ALQIMI Analytics & Intelligence, LLC, Rockville, MD (US)

(72) Inventors: Walter GREENBERG, Rockville, MD (US); Kevin M. DONOHUE, Rockville, MD (US)

(21) Appl. No.: 15/224,211

(22) Filed: Jul. 29, 2016

(51) Int. Cl. G06F 17/30

(52) U.S. Cl. CPC G06F 17/30867; G06F 17/30076; G06F 17/30929; G06F 17/30941

(57) ABSTRACT

Some embodiments are directed to a method for exchanging data between a user and a data source, the method including configuring a non-transitory computer readable medium to retrieve and display a set of data from the data source via a data source query in accordance with connection information, a set of display options and data retrieval filters specified in a user-defined XML configuration file. Further, the data exchanged between the user and the data source passes through an application server and a portal server.

### BACKGROUND

The disclosed subject matter relates to data retrieval, and more specifically to a system and methods for displaying data retrieved from remote data sources on a web portal. In particular, the disclosed subject matter relates to a portal with one or more portlets that are designed to display information from diverse data sources. Retrieved data is typically presented in web pages or web-based graphical user interfaces.

The web portal is a single web site that brings information together from diverse sources in a uniform way. Generally, each information source gets its dedicated area on the page for displaying information, which is known as a portlet. Portlets are pluggable user interface software components that are managed and displayed in a web portal. Further, portlets can be considered as building blocks for creating complex web portals with sophisticated features.

Services relating to data retrieval can be implemented as software components that provide content and/or functionality to remote web applications through the Internet. Remote applications can submit requests for information to web services and receive content in return. Similarly, applications can pass queries to web services by deploying configuration files that contain information regarding the data source, various search filters and display options. A result is returned from the web service to the application based on the queries. Web service content can be passed to a client of the application where it can be displayed, processed, or otherwise utilized.

### SUMMARY

The related art includes various applications for retrieving data from data sources and displaying the retrieved data on user or client terminals are well known. However, each application can retrieve only a specific type of data or data from a specific data source. Further, such applications also need to be present locally on a user or a client terminal.

Some related art systems access data from multiple data sources and store the retrieved data in a data warehouse. The data stored on the data warehouse is then displayed on the client or user terminals. However, the data stored in the data warehouse may be in a raw format and further formatting of the data is required before the data can be displayed. Further, data retrieval processes are generally implemented by an application server. An application server can be any software framework that facilitates the creation of web applications and a server environment to run them. It behaves as a virtual machine to run applications and handles connections to data sources on one end and connections to the client terminal or user terminal through a web client or web portal on the other end. Often, using only an application server or a cluster of application servers can limit the dynamic delivery of information. Additional processing functions need to be performed by an end-user or client to obtain information in a customized format. Complex client applications are required to process the data retrieved.

Some related art systems use applications present on the client terminals to format and display retrieved data. However, such applications format the retrieved data based on predefined algorithms without providing any option to a user to control the presentation of the retrieved data.

It may therefore be beneficial to provide systems and methods to retrieve data from one or more data sources and display the data in accordance with user-defined display options and data retrieval filters. Specifically, it may be beneficial to generate one or more portlets to facilitate retrieval of data in a legible format without using any applications stored locally on a client or user terminal. One or more portlets are generated by a portal server in an application server environment to facilitate a single point of access to data from data sources for end-users or clients.

It may therefore be beneficial to provide systems and methods to retrieve data from one or more data sources and display the data in accordance with user-defined display options and data retrieval filters. Specifically, it may be beneficial to provide at least an application server and a portal server to facilitate retrieval of data in a legible format utilizing any applications stored on the application server.

It may also be beneficial to provide systems and methods to retrieve data from multiple data sources and store the retrieved data in a database in a predefined format. The stored data is displayed in accordance with user-defined display options and data retrieval filters without the need for any local applications or programming to format the retrieved data.

It may also be beneficial to provide a specification-compliant, end-user-configurable portlet allowing a user to quickly access and retrieve database data using a portal server and an application server, and present the retrieved data in a useful format, without programming. Using a web-interface designed for a non-technical end-user, a series of data-presentation options may be selected or configured and saved to an XML (Extensible Markup Language) configuration file. A portal server, with the portlet installed, may be used to present a view of the data as per the configuration options stored in the user-defined XML configuration file. Examples of available configuration options include data retrieval filters, data export formats (XML format, Comma Separated Values or CSV format), and various levels of summary and detail.

It may also be beneficial to provide methods enabling a user to create one or more configuration files which can dictate certain display options. For example, each configuration file might correspond to a specific user's desired data feeds and/or display options

Some embodiments are directed to a method for exchanging data between a user and a data source, the method including configuring a non-transitory computer readable medium to access a set of data from the data source via a data source query in accordance with options specified in a user-defined XML configuration file, the user-defined XML configuration file further specifying a set of display options. The method further includes retrieving the set of data from the data source in accordance with data retrieval filters specified in the user-defined XML configuration file and displaying the set of data in accordance with the set of display options specified in the user-defined XML configuration file. Further, the data exchanged between the user and the data source passes through an application server and a portal server.

Some other methods are directed to a method of retrieving data from a data source, the method including receiving, through a portal server, a data source query comprising a set of display options and a set of data retrieval filters, the set of display options and the set of data retrieval filters corresponding to the data source. The method also includes embedding the set of data retrieval filters and the set of display options into a user-defined XML configuration file. The method further includes retrieving, by an application server, a set of data from the data source in accordance with the set of data retrieval filters embedded in the user-defined XML configuration file, wherein the application server is communicably coupled with the portal server. The method also includes storing the set of data in a database associated with the application server in accordance with a predefined format and, receiving, at the portal server, the set of data stored in the database. The method further includes generating, by the portal server, one or more portlets to display the set of data to the user in accordance with the set of display options and the predefined format.

Yet other embodiments are directed to a system for exchanging data between a user and a data source, the system including a portal that is configured to receive a data source query from the user, the data source query corresponding to the data source. The system further includes a processor that is configured to generate a user-defined XML configuration file based on the data source query, the user-defined XML configuration file including a set of display options and a set of data retrieval filters. The system also includes an application server communicably coupled to the portal, the application server configured to retrieve a set of data from the data source in accordance with the set of data retrieval filters specified in the user-defined XML configuration file, and store the set of data in a database in accordance with a predefined format. The system also includes a portal server communicably coupled to the portal and the application server, the portal server configured to generate one or more portlets to display the set of data through the portal in accordance with the set of display options and the predefined format.

As mentioned above, the disclosed systems and methods address a problem occurring in related art processing devices that utilize data portlets, in that there can be numerous difficulties in attempting to process a data portal (portlet) query through an application server (servelet) and vice-versa. Furthermore, related art devices have not addressed an application allowing data retrieval filters to be specified in a user-defined XML configuration file that can subsequently be transmitted through both application servers and data portals reliably, and culminating in a desired query/display outcome. Additionally, daisy-chained portlet-servelet systems have not yet been configured to exchange portlet information associated with a data integration portlet (DIP) as described in (5078-0002), which is hereby incorporated by reference in its entirety. This deficiency is due, in part, to the fact that data portlets have become a less fervent area of software development, despite remaining crucial cornerstones in a number of software development projects and applications. Furthermore, daisy-chained servers can present even greater problems as differing query filters, display configuration options, and other configuration parameters that attempt to either access data from differing server types or simply traverse queries across differing server types to return viable results can be subject to technological mismatches and result in fundamental differences in data returned between differing data processing server systems.

Some of the disclosed embodiments address this problem by creating an XML configuration file for any given query and storing these files for future use. The XML configuration file can act like a cascading style sheet (CSS) for a website's display, with the exception that the configuration file can also apply data filters, query terms, etc. (in addition to display configuration parameters). Furthermore, numerous XML configuration files can be stored (e.g., one per data portal query), each of which causes the computer to provide a different display with differing returned results. These files can be compiled at the initiation of the software all at once, saving time once a user selects a given pre-determined query as the information is already downloaded and in queue.

In addition to the generation of such XML configuration files, some advantages of the embodiments disclosed in the instant application are the ability to transmit the said configuration files through both data portal servers (portlets) and application servers (servelets) without losing, corrupting, or otherwise disturbing the portlet-based DIP data in the process, nor requiring the data to be re-routed to portal or non-application specific servers when a query is made. Further, in some embodiments, the application server can be configured to act as a portal server, such as with virtual machine (VM) technology, that would allow the portal software configuration, query strings, etc. to run from a servelet, or on a portlet after having passed through any number of application and/or portal servers prior to reception at a portlet.

### BRIEF DESCRIPTION OF DRAWINGS

The foregoing and other aspects of the embodiments disclosed herein are best understood from the following detailed description when read in connection with the accompanying drawings. For the purpose of illustrating the embodiments disclosed herein, there is shown in the drawings embodiments that are presently preferred, it being understood, however, that the embodiments disclosed herein are not limited to the specific instrumentalities disclosed. Included in the drawings are the following figures:

FIGS. 1A, 1B and 1C illustrate various exemplary systems for retrieving and displaying data in accordance with the disclosed subject matter.

FIGS. 2A and 2B illustrate various embodiments for a Data Integration Portlet and an application in accordance with the disclosed subject matter.

FIG. 3 is a schematic of a user interface shown on a portal page in accordance with the disclosed subject matter.

FIG. 4 is a flowchart of an exemplary method of retrieving data in accordance with the disclosed subject matter.

FIG. 5 is a flowchart of an exemplary method of retrieving data in accordance with the disclosed subject matter.

FIG. 6 is a computer system that can be used to implement various exemplary embodiments of the disclosed subject matter.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

### I. Server Environment

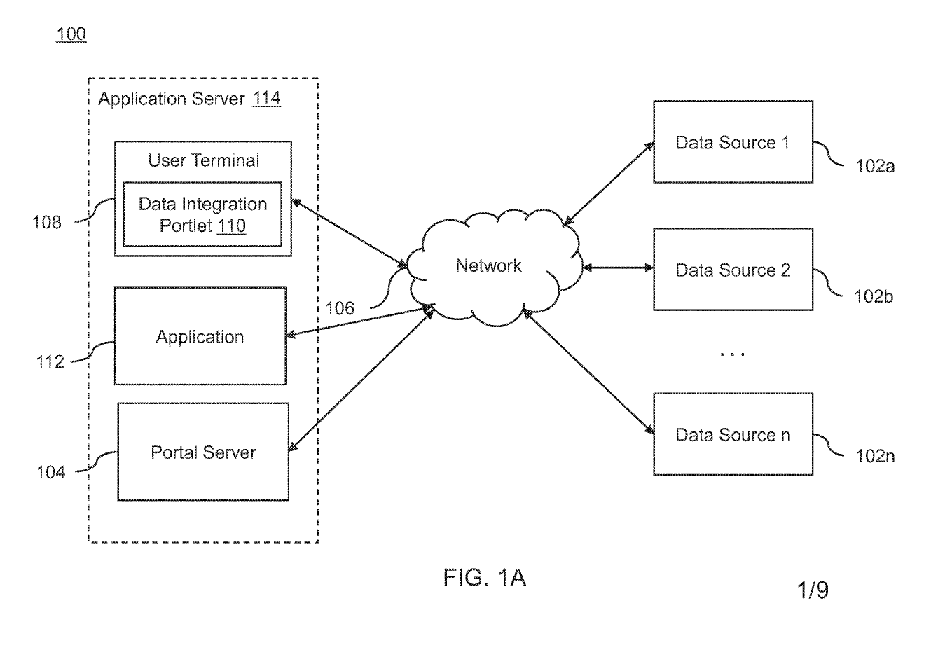

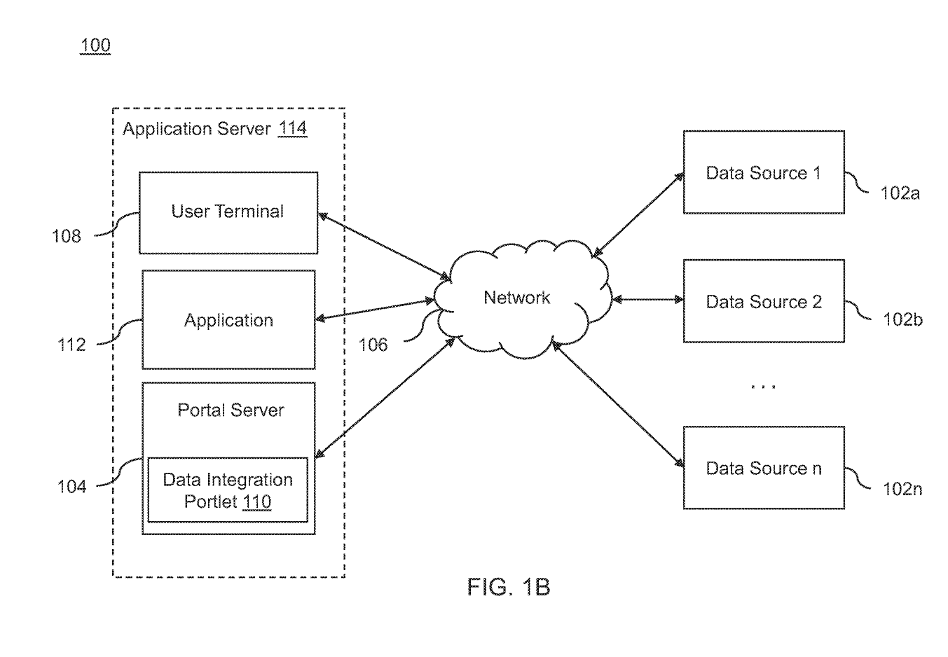

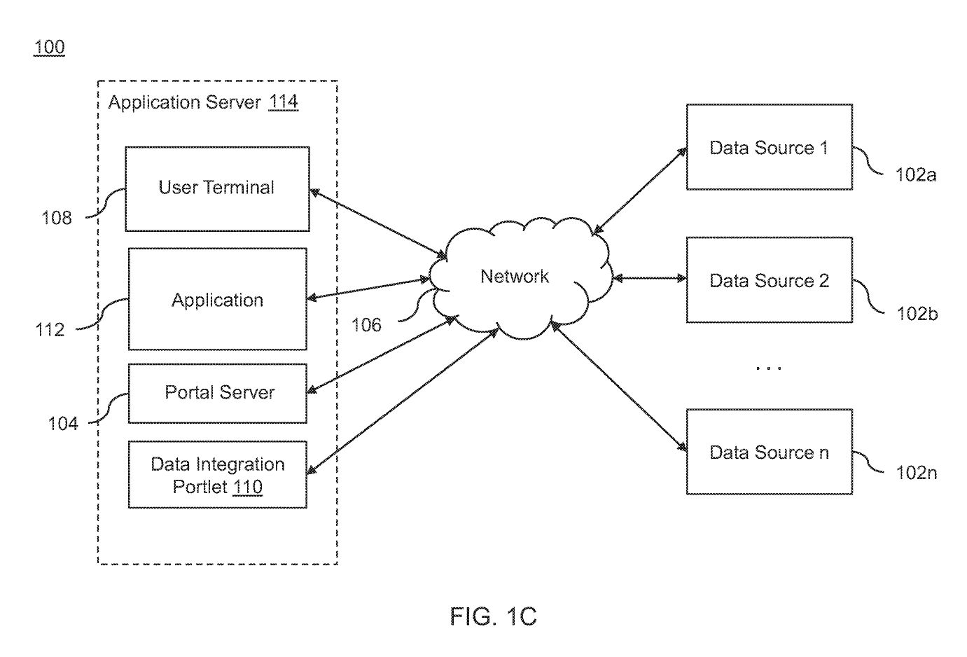

FIG. 1A is an illustration of a system 100 in accordance with the disclosed subject matter. The system 100 is configured to retrieve and display data. Specifically, the system 100 facilitates exchange of data between a user terminal 108 (hereinafter user 108) and one or more data sources 102 through one or more portlets installed on a portal server 104. The portal server 104 is further run on an application server 114. The application server 114 is configured to be a platform for the portal server 104, an application 112, and the user terminal 108. Specifically, the application server 114 provides an environment in which the portal server 104 can operate. In some instances, the portal server 104 may be positioned in series with the user terminal 108, or may even be configured as a part of the user terminal 108 itself (such as an app, an Operating System routine, or the like). The data to be exchanged is retrieved in accordance with an Extensible Markup Language (XML) configuration file that may contain various types of information. This information can include, but is not limited to, connection information, display preference information, and user query information. The XML file can also include data retrieval filters, keywords, metadata or metadata tracking information and so forth.

The data sources 102a to 102n (hereinafter collectively termed 102) are intended to be any type of data source including social media networks, search engines, portals, remote servers, network storage units, etc. Embodiments are also intended to include or otherwise cover any other type of data source. The data sources 102 are merely provided for exemplary purposes, and the various inventive aspects are intended to be applied to any type of data source on a network 106 connected to the portal server 104, the application 112 and the user terminal 108.

The network 106 may include a data network such as, but not restricted to, the Internet, local area network (LAN), wide area network (WAN), metropolitan area network (MAN), etc. In certain embodiments, the communication network 106 can include a wireless network, such as, but not restricted to, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS) etc. In some embodiments, the communication network 106 may include or otherwise cover networks or subnetworks, each of which may include, for example, a wired or wireless data pathway. The communication network 106 may include a circuit-switched voice network, a packet-switched data network, or any other network capable for carrying electronic communications. For example, the network 106 may include networks based on the Internet protocol (IP) or asynchronous transfer mode (ATM), and may support voice usage, for example, VoIP, Voice-over-ATM, or other comparable protocols used for voice data communications. In one implementation, the network 106 includes a cellular telephone network configured to enable exchange of text or SMS messages.

Examples of the network 106 may further include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth. Embodiments are intended to include or otherwise cover any type of network, including known, related art, and/or later developed technologies to connect the data sources 102, the portal server 104 and the user 108 with each other.

The user 108 is intended to include any electronic device, such as desktop computers, portable computers, smartphones, tablet computers, wearable devices, and the like. The user 108 may also include a display unit (not shown) for displaying any data. The display unit can include, but not limited to, a Cathode Ray Tube (CRT) display, a Liquid Crystal Display (LCD), a Light Emitting Diode (LED) display, and the like. Embodiments are intended to include or otherwise cover any type of display, including known, related art, and/or later developed technologies.

The portal server 104 generates a Data Interchange Portlet 110 that is a specification compliant, end-user-configurable portlet that allows a user 108 to quickly access and return database data using a portal server and present it in a useful format, without programming beyond the generation of the user-defined XML configuration file. In some embodiments, the DIP 110 may be part of the user 108, as seen in FIG. 1A. In some other embodiments, the DIP 110 may be part of the portal server 104 (shown in FIG. 1B) or may be placed next to the user 108 (shown in FIG. 1C). The portal server 104 runs on the top of the application server 114. In an embodiment, elements of the DIP 110 are integrated into the application 112.

The application 112 can contain a non-transitory computer readable medium that can be configured by a computer processor to perform various operations related to the application server 114 and/or the portal server 104. The non-transitory computer readable medium can contain a set of instructions written in various programming languages, such as, C, C++, Java, Python, and so forth.

In some embodiments, the application 112 can be implemented as a servlet on the application server 114. The servlet is a java program that extends the capability of a server. Specifically, the servlet implements applications hosted on the server by receiving a request and generating a response based on the request. Further, the servlet can define Java objects that represent servlet requests and their responses, the configuration parameters of the servlet and an execution environment. Servlets may be packaged in a Web application ARchive file (WAR file) as a web application.

In some embodiments, the application 112 includes pages, portlets, communication channels between the portlets etc. The application 112 can act as an interface between the portal server 104 and the data sources 102. The application 112, the portal server 104 and the user 108 further run on an application server environment provided by the application server 114.

The application server 114 can be a software framework that provides a platform for the application 112, the portal server 104 and the user terminal 108. The application server 114 acts as a set of components accessible to a software developer through an application program interface (API) defined by the platform of the application server 114. The application server 114 can be tasked with the construction of dynamic pages for the application 112. The application server 114 may include instructions that are stored in a computer readable medium and executed by a computer processor associated with the application server 114. The application server 114 may provide various types of services used by an organization. In some embodiments, services served by the application server 114 may include a database storage tool that stores data retrieved from one or more data sources in the form of files and/or tables in a database and selectively allows access to these files and/or tables based on a query from an end-user. Data stored may include tags indicating the type of data and the source from which the information is retrieved. In response to the query from the DIP 110 to access one or more files and/or tables in the database, the portal server 104 reads the tags of files and displays the appropriate information at the user 108.

The application server 114 may also include a non-transitory computer readable medium, which when executed by the associated computer processor, carries out various functionalities of a web-interface. Though the web-interface is designed for a non-technical end-user, a series of data-presentation options may be selected (configured) and saved into an XML (Extensible Markup Language) configuration file. The user-defined XML configuration file can also be manually configured. For example, the user-defined XML configuration file may be configured in a word processing application. The portal server 104, with the DIP 110 installed, is used to present a view of the data as per the configuration options stored in the user-defined XML configuration file. Examples of available configuration options include data retrieval filters, data export formats (XML format, csv format), and various levels of summary and detail. The user-defined XML configuration file may include artistic guidelines, such as displaying a three-day weather forecast in the top-left corner of a portal page, and news in the bottom-right corner the portal page. The XML file may also be arbitrarily specific, such as weather in Seattle being displayed in the top left of the portal page, while arrest reports from anyone in Miami named “Edward” being displayed in the bottom right corner of the portal page.

In some embodiments, a processor (not shown) associated with the user 108 may generate the user-defined XML configuration file and store it on a memory (not shown) associated with the user 108. Further, the portal server 104 may be communicably coupled to the user 108 in order to access the configuration options stored in the user-defined XML configuration file and to the application 112 in order to receive a set of data stored in a predefined format. In other embodiments, the processor, that generates the user-defined XML configuration file, may be associated with the portal server 104.

The portal can be a web portal or an enterprise portal and is configured to aggregate data from different sources and display the aggregated data. In an embodiment, the portal is a web page that brings information together from diverse sources. In some other embodiments, the portal is configured to receive a data source query from the user 108. The data source query further corresponds to a specific data source. Each piece of information from the specific source gets a dedicated display or presentation area on the portal as defined by an end-user or web designer. The dedicated display or presentation area can be handled or managed by one or more portlets. Portlets are applications used by a data portal website to receive requests from a client terminal or a user terminal and return information. In some embodiments, the portal server 104 is the middleware between an application server 114 and the user 108. The portal server 104 can run on top of an application server or a cluster of application servers. In some other embodiments, the application server 114 and the portal server 104 are communicably coupled to the portals at the user 108. The application server or the cluster of application servers can host web applications related to data retrieval.

### II. Portals and the Data Integration Portlet

A web portal is a specially designed web site that brings information together from diverse sources in a uniform way. Usually, each information source gets its dedicated area on the page for displaying information (a portlet); often, the end-user can configure which ones to display. Variants of portals include mashups and intranet “dashboards” for executives and managers. The extent to which content is displayed may depend on the intended end-user and the intended purpose, as well as the diversity of the content. Very often design emphasis is on a certain “metaphor” for configuring and customizing the presentation of the content and the chosen implementation framework and/or code libraries. In addition, the role of the end-user in an organization may determine which content can be added to the portal or deleted from the portal configuration.

A portal may use a search engine Application Program Interface (API) to permit end-users to search intranet content as opposed to extranet content by restricting which domains may be searched. Apart from such common search engine feature, web portals may offer other services such as e-mail, news, stock quotes, information from databases and even entertainment content. Portals provide a way for enterprises and organizations to provide a consistent look and feel with access control and procedures for multiple applications and databases, which otherwise would have been different web entities at various Uniform Resource Locators (URL). The features available may be restricted by whether access is by an authorized and authenticated end-user (employee member) or an anonymous site visitor.

Portal servers provide a central platform for accessing web content and resources (data, docs, apps, integrations, alerts, etc.). A core feature of a portal is to provide a central URL that permits an end-user to have a custom web experience based upon the end-users' login identity. This functionality is termed role-based content delivery, or RBCD, and is a main focus for portals.

Websites based on Role-based Content Delivery (RBCD) allow an enterprise to develop a central web platform. Enterprises can then advertise a single website, and thereby increase the usage of the entire enterprise's resources as the central portal can integrate or guide end-users to other resources. RBCD has allowed administrators to build portal pages for different end-user types to customize the end-user experience based on an end-user's “formal identity,” such as a salesperson, engineer or manager.

Given that portal pages can include both applications (portlets and widgets) and web content, many portals have begun supporting integration to an external web content management system (WCMS) allowing content to be created or managed in a WCMS that appears in a portal page. In some embodiments, the portal page is configured to receive a data source query from an end-user. This two-step process of adding content prompted some other portals to create an embedded WCMS.

Portals additionally have begun to focus on end-users, allowing such end-users to interact with the system. End-users are often allowed to create their own pages or sites, to add collaboration apps to those pages and to define end-user access to those pages. Many portals also enable power end-users to have added features, such as web forms, workflows, dynamic lists and polls.

This focus on enabling the end-user, combined with RBCD, allows a central site to enable both the formal organizational structure as well as the informal organizational structure (i.e., social collaboration) and is a major difference between portals and many WCMS systems.

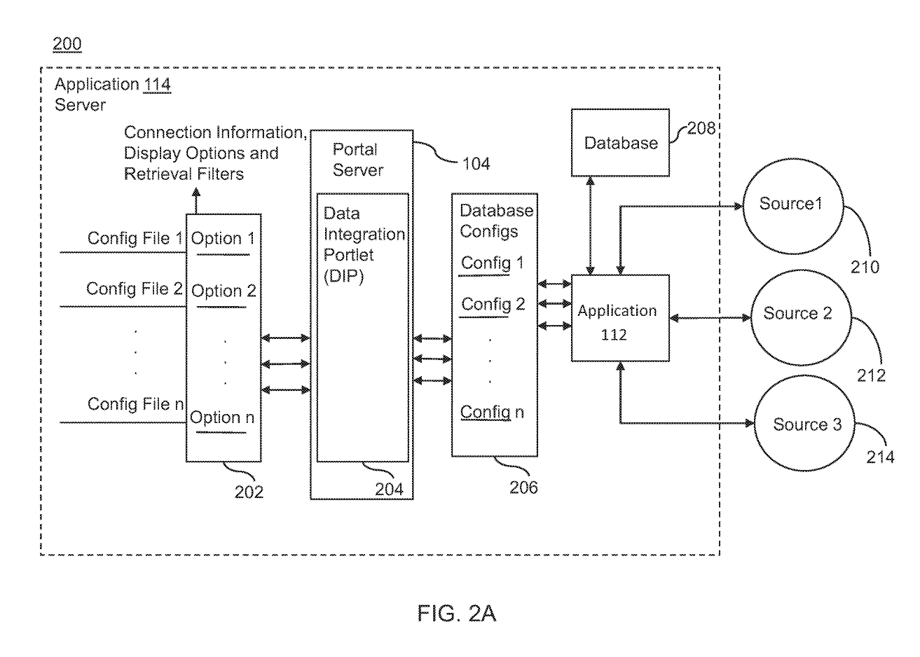

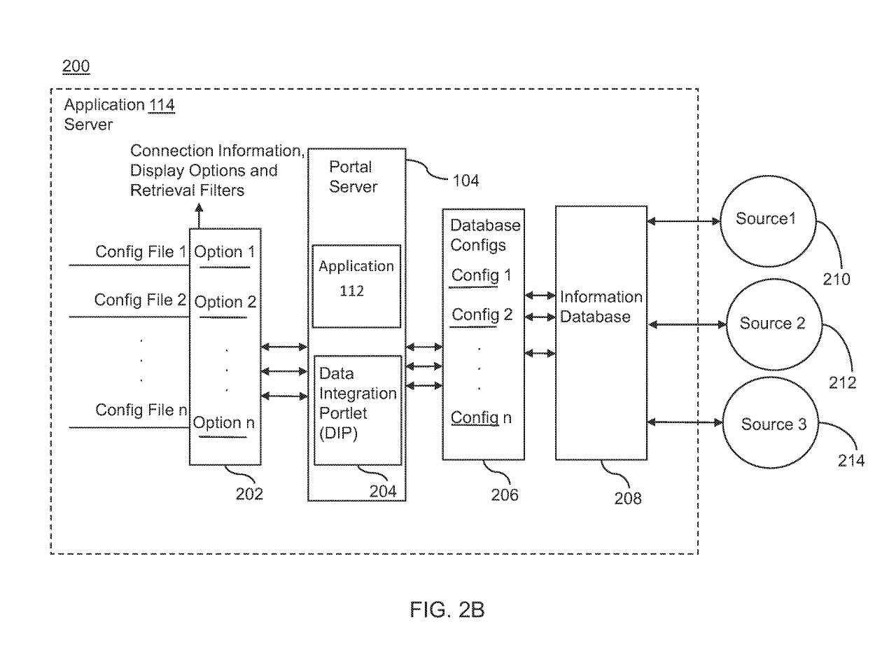

FIGS. 2A and 2B illustrate various embodiments of a system 200 including a Data Integration Portlet (DIP) 204 in conjunction with the user 108 and data sources 210, 212 and/or 214. As illustrated in FIG. 2A, the user 108 can create one or more configuration files (1-n as shown in FIG. 2A) which can dictate certain display options. For example, each configuration file can correspond to a specific user's desired data feeds and/or display options 202 (e.g., configuration file 1 for John, configuration file 2 for Heather, and so forth). Alternatively, configuration files can correspond to different topics of interest, such as weather forecasts around a country (configuration file 1), political news (configuration file 2), etc. The configuration files set the display options that can ultimately appear in the portal page.

The user 108 can create queries based on the data to be retrieved. Each query can create one or more configuration files. The queries may include, but are not limited to, data retrieval filters and/or display options. The configuration file information can include connection information, display options and data retrieval filters. Connection information includes, but not limited to, IP addresses, subnet masks, domain name server addresses, host name and suffix, execution parameters, system information pertaining to the user 108 and/or the portal server 104. Display options include, but are not limited to, at least one of a tabular layout, a chart layout, a news layout, a form layout, and a bullet layout. The data retrieval filters include one or more identities indicative of a data sources, for example, the data source 210, the data source 212 and/or the data source 214.

The portal server 104 is configured to generate one or more portlets on a portal page. The portlets are further configured to display the set of data retrieved form the data source 210, 212 and/or 214 through the application 112. The portal server 104 may be communicably coupled to the user 108 in order to access the configuration options 202 stored in the user-defined XML configuration file. One or more user-defined XML configuration files provide connection information, user-defined display options and data retrieval filters to the portal server 104 using the DIP 204 installed in the portal server 104.

In some embodiments, the connection information, the user-defined display options and the data retrieval filters form a user-defined query or a data source query. The data source query further includes one or more identities indicative of the data source, one or more sets of keywords, and the set of display options. Each user-defined XML configuration file is extracted to a configuration file database 206 and uses a single query defined by the user 108 that may retrieve data from multiple tables within an information database 208 through the application 112.

With reference to FIG. 2A, the application 112 runs on the application server environment and is communicably coupled to the portal server 104 and to the data sources 210, 212 and 214. The application 112 includes a non-transitory computer readable medium which is configured to access a set of data from the data sources 210, 212 and/or 214 using the data source query based on the options specified in the user-defined XML configuration file. The user-defined XML configuration file further specify a set of display options, a set of data retrieval filters and communication information. The application 112 on the application server 114 extracts the user-defined XML configuration file from the configuration file database 206 and selects a data source based on the user-defined XML configuration file. The application 112 further, retrieves the set of data from the data source based on the data retrieval filter specified in the user-defined XML configuration file. In some embodiments, the application 112 may access the connection information stored in the user-defined XML configuration to retrieve the set of data from the data source. The application 112 transforms the set of data retrieved from the data source into a predefined format and stores it in the information database 208.

The information database 208 may be a relational database and/or an object-relational database. The information database 208 organizes data into one or more tables of columns and rows with a key identifying a row and/or column in each table. The keys for each row and/or column are used to define logical connections (called relationships) among the tables. Based on the user-defined queries, the data residing in the tables are manipulated such that the data is presented at the user 108 in a legible format. The data stored in multiple tables on the information database 208 is retrieved from any or all of the data sources 210, 212 and/or 214 by the application 112. In some embodiments, the data may be retrieved in real time as per the user query received at the portal server 104. In some other embodiments, the data may be retrieved and stored in the information database 208 before a user query is received at the portal server 104.

In some embodiments, the configuration file database 206 may be a relational database that contains the user-defined queries retrieved from the user-defined XML configuration files. The data retrieval filters and the display options are stored in one or more tables with a key identifying a row and/or column in each table. The data is retrieved from the data sources 210, 212 and/or 214 based on the data retrieval filters specified in the user-defined XML configuration file. Further, the retrieved data is displayed on the user 108 based on the set of display options specified in the user-defined XML configuration file. The keys are used to define logical connections or relationships among the tables.

The portal server 104 can transform the data retrieved from the data source 210, the data source 212 and/or the data source 214 in accordance with the predefined format and populate the tables of the information database 208 with the data retrieved from the data sources 210, 212 and/or 214. The portal server 104 can implement various algorithms to convert or transform the retrieved data including, but not limited to, statistical methods, probabilistic methods, and so forth. In case, any data does not include an entry corresponding to any of the tables, the tables are left blank. Therefore, the information database 208 may allow standardization of data from different data sources, and enable quick display of the stored data in accordance with the predefined format and the display options.

The portal server 104 extracts the data stored in the information database 208 through the application 112 based on the user-defined XML configuration file stored in the configuration file database 206. The retrieved data is further displayed through the DIP 204 based on the display option specified by the user.

In an alternate embodiment, as shown in FIG. 2B, the application 112 is installed within the portal server 104. The application 112 enables the portal server 104 to generate one or more portals. The portal server 104 acts as a single access point for the user 108 to retrieve data from the data sources 210, 212 and/or 214. Data extracted by the portal server 104, using the application 112, is stored in the information database 208 in the predefined format. The predefined format corresponds to the data being organized in multiple tables with a key identifying a row and/or column in each table in the data. The keys are used to define logical connections between the rows and columns of one table and the rows and columns of another table.

Using the application 112, the portal server 104 extracts the data from the information database 208 based on the user-defined XML configuration file stored in the configuration file database 206. Further, the extracted data is displayed at the user 108 through the DIP 204 based on display options specified in the user-defined XML configuration file.

The portal server 104, the application 112 and the user 108 run on the application server environment provided by the application server 114. The application server 114 is a software framework that facilitates the creation of the application 112 and a server environment to run them. It behaves as a virtual machine to run the application 112 and handles connections to the data sources 210, 212 and/or 214 on one end and connections to the user 108 on the other.

In some embodiments, the user queries, the display options and the data retrieval filters may be obtained via a user interface which will be described in detail hereinafter.

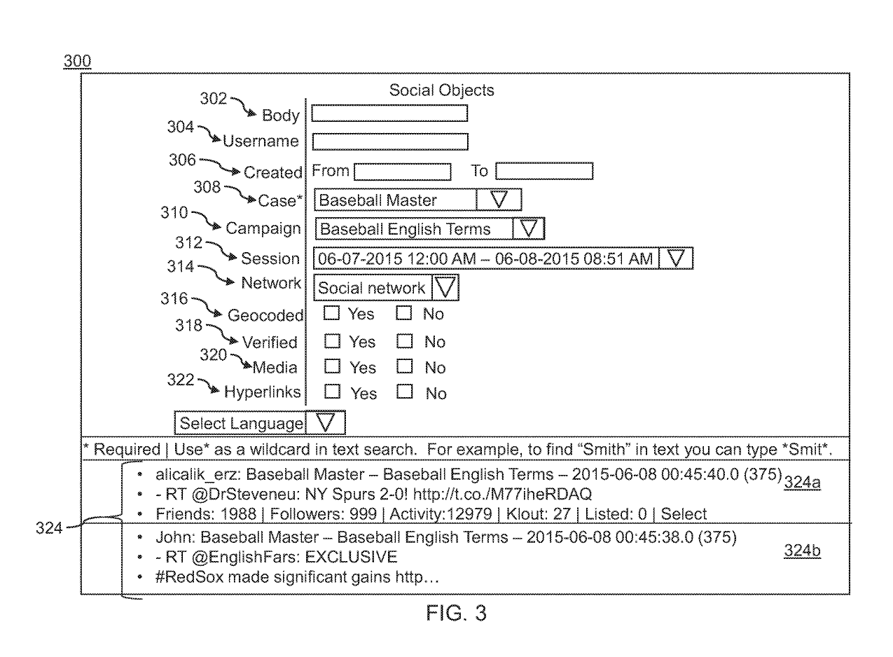

FIG. 3 illustrates an exemplary embodiment of a user interface 300 presented on the user 108. The user interface 300 includes fields for various query parameters. The fields include, but are not limited to, a body field 302, a username field 304, a query creation dates field 306, a query title or case field 308, a language of retrieved data field 310, date/time stamp details field 312, a data source field 314, location filters field 316, authenticate filters field 318, a selection field 320 for the retrieval of images, videos and/or audio, and a field 322 for hyperlink filters. Results field 324 is displayed according to choices made in the aforementioned fields. Each of the fields 302 to 322 and the results field 324 correspond to one or more portlets generated by the portal server 104. Further, the results field 324 is displayed through a first portlet 324a and a second portlet 324b. The first and second portlets 324a, 324b may be generated by the portal server 104.

Choices made on the user interface 300 form the data source query and is embedded into an Extensible Markup language (XML) configuration file stored on the user 108. An example of the information stored in the user-defined XML configuration file is shown below:

<QuerySettings>

<DatabaseVendor>PostgreSQL</DatabaseVendor>
<Connection>

<ConnectionID>2</ConnectionID>

</Connection>
<QueryString>SELECT verifiedimg, verifiedyn, username,

displayname, authorkloutscore, useractivitycount, friends,
followers, listedcount, favoritescount, retweetcount,
generator, verified, profileimgurl, network, created, createdyear,
createdmonth, createdday, body, isre, origobjsrcid, objectsrcunid,
origauthor, sourceid, hashtags,
languages, expandedurls, verb, usermentionsnames, usermentionsids,
mediaurls, lon, lat, headline,
tagline, createdby, objectcreateddate, geocoordinates,
linktoobject, resultid, Geocoded, globe, resultid, id, userbiolocation,
mediatype, usermentionsscreennames, actorid, verified, userbiolocation,
sentiment_tag, sentiment_score, user_sentiment_votes,
user_sentiment_average, user_sentiment_mode,
user_sentiment_median, mediayn, tsv_body

The above is a snippet from an exemplary user-defined XML configuration file used in accordance with the disclosed subject matter. Each user-defined XML configuration file uses a single query extracted from inputs received through the user interface 300 to retrieve data from multiple tables within the information database 208.

The user-defined XML configuration file is used for the processing, definition and presentation of data on the user interface 300. Through the user-defined XML configuration file, code is specified for formatting various layouts and styles pertaining to presentation of data. The user-defined XML configuration file, as seen in the sample code above, includes the user-defined query that further includes communication information, display options and data retrieval filters. The user-defined XML configuration file provides connection information to enable a connection between the user 108 and the information database 208 (in the current example the information database 208 being an object-relational database provided by PostgreSQL®). The multiple fields 302 to 322 may be populated by an end-user. Based on the information provided through the fields 302 to 322, various display options and data retrieval filters, such as the tags provided in the XML code above, are enabled and form a user-defined query. The XML configuration file further acts as a tool to transport the user-defined query information from the user 108 to the configuration file database 206 and the information database 208. Subsequently, based on the user-defined query, the portal server 104 extracts the data corresponding to the retrieval filters specified at the fields 316 to 322 from the data source specified at the field 314. The data is extracted in a predefined format at the information database 208. Subsequently, the extracted data is presented based on the display options specified in the user-defined query through the portlets at the results field 324 shown in FIG. 3.

In order for a query, such as that shown in the XML sample above, to retrieve data from multiple sources, the data would need to exist in any of the data sources 210, 212 and 214 and in the information database 208 specified in the query.

The database connection details or connection information, such as that referenced in the XML code above, are specified in the same user-defined XML configuration file or in a separate user-defined XML configuration file.

### III. Exemplary Embodiments

In an exemplary embodiment, a user-defined XML configuration file is generated at the user 108 with a data source query embedded therein. The data source query includes connection information, a set of data retrieval filters and a set of display options. As shown in FIG. 3, the fields 302 to 322 are populated such that user-defined options relating to data retrieval filters and display options are specified. As shown in the sample XML code above, the populated fields 302 to 322 enable selections of the query strings such that the data source query is created and embedded into the user-defined XML configuration file. Using the DIP 204 that is installed on the portal server 104, the data source query, along with other configuration information contained in the user-defined XML configuration file, is transmitted to the configuration file database 206. As shown in FIG. 2A, the application 112, installed on the application server 114, stores data retrieved from the data source 210, the data source 212 and/or the data source 214 at the information database 208. The data may be retrieved prior to the data source query being received at the configuration file database 206. In some embodiments, the application 112 may retrieve the set of data based on the user-defined XML configuration file upon receiving the user query. The retrieved data is stored on the information database 208 in a predefined format. The predefined format includes the retrieved data being stored in multiple tables with each row and/or column of each table being identified by a key. The keys are used to establish logical connections between rows and columns of one table with the rows and columns of another table in the information database 208. Based on the data source query stored in the tables of the configuration file database 206, the application 112 extracts a set of retrieved data, corresponding to any one of the data sources 210, 212, and/or 214, from the tables of the information database 208 and displays the retrieved data on the user interface 300 (as shown in FIG. 3) at the portlets 324a and 324b.

Alternately, as shown in FIG. 2B, the application 112 is installed within the portal server 104. The application 112 enables the portal server 104 to generate one or more portals. The portal server 104 acts as a single access point for the user 108 to retrieve data from the data sources 210, 212 and/or 214. Data retrieved by the portal server 104 using the application 112, is stored at the information database 208 in the predefined format. Using the application 112, the portal server 104 extracts the data from the information database 208 based on the user-defined XML configuration file. Further, the extracted data is displayed at the portlets 324a and 324b based on display options specified in the user-defined XML configuration file.

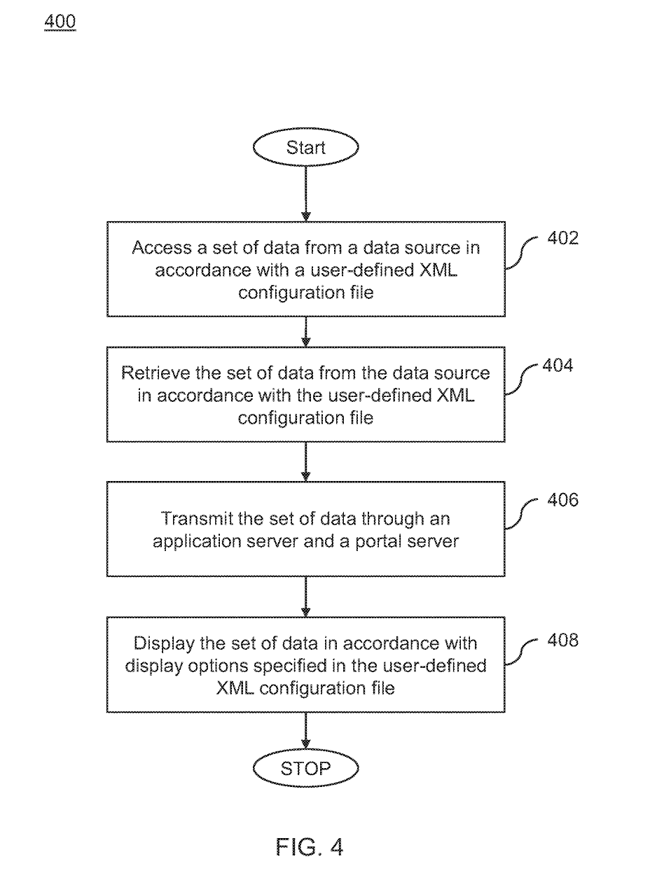

FIG. 4 illustrates a method 400 of retrieving data from one or more data source in accordance with the disclosed subject matter. This flowchart is merely provided for exemplary purposes, and embodiments are intended to include or otherwise cover any methods or procedures for data retrieval.

In accordance with the flowchart of FIG. 4, at step 402, a non-transitory computer readable medium is configured to access a set of data from a data source based on a data source query in a user-defined XML configuration file. Further, the user-defined XML configuration file is configured to specify a set of display options. In some embodiments, a processor (not shown) associated with the user 108 generates the user-defined XML configuration file and stores it on a memory (not shown) associated with the user 108. In some embodiments, the non-transitory computer readable medium is part of the application 112.

In some embodiments, the application server 114 includes the application 112. The application 112 can contain the non-transitory computer readable medium that can be configured by a computer processor to perform various operations related to the application server 114 and/or the portal server 104. The data source 210, 212 and/or 214 is selected through choices on the form-based user interface 300 and the choices are embedded into the user-defined XML configuration file stored on the user 108.

At step 404, the non-transitory computer readable medium retrieves the set of data from the data source 210, the data source 212 and/or the data source 214. The retrieved data is stored in tables of the information database 208 in accordance with a predefined format. The predefined format is a presentation format that is implemented in accordance with the display options made available through the XML configuration file and subsequently the form-based user interface 300. Such a format facilitates data retrieval processes in a customized presentation as defined by the user 108. In some embodiments, the connection information stored in the user-defined XML configuration file is accessed through the non-transitory computer readable medium to create a network link between the user 108, the portal server 104, the application server 114 and any one or a combination of the data sources 210, 212 and/or 214. In some other embodiments, the non-transitory computer readable medium may transform the set of data retrieved from the data source to the predefined format. At step 406, the transformed set of data is transmitted by the application 112 to the portal server 104. Therefore, the retrieved data passes through both the application server 114 and the portal server 104. Further, in some embodiments, the retrieved data may pass from the application server 114 to the portal server 104, and subsequently to the user 108. In other embodiments, the retrieved data may pass from the portal server 104 to the application server 114, and subsequently to the user 108.

At step 408, the portal server 104 generates one or more portlets to display the transformed set of data in accordance with a set of display options specified in the user-defined XML configuration file at the user 108 via the results field 324.

Further, the data exchange between the user 108 and the data source 210, 212 and/or 214 passes through the application server 114 and the portal server 104. In some embodiments, the set of data stored in the information database 208 is received at the portal server 104. FIG. 3 further illustrates an exemplary embodiment of the aforementioned process wherein information is sought from a social network concerning “Baseball” with other filters implemented. The data set is retrieved from the social network; the details of the social network being provided at the data source field 314. Accordingly, data pertaining to “baseball” is displayed at the portlets 324a and 324b.

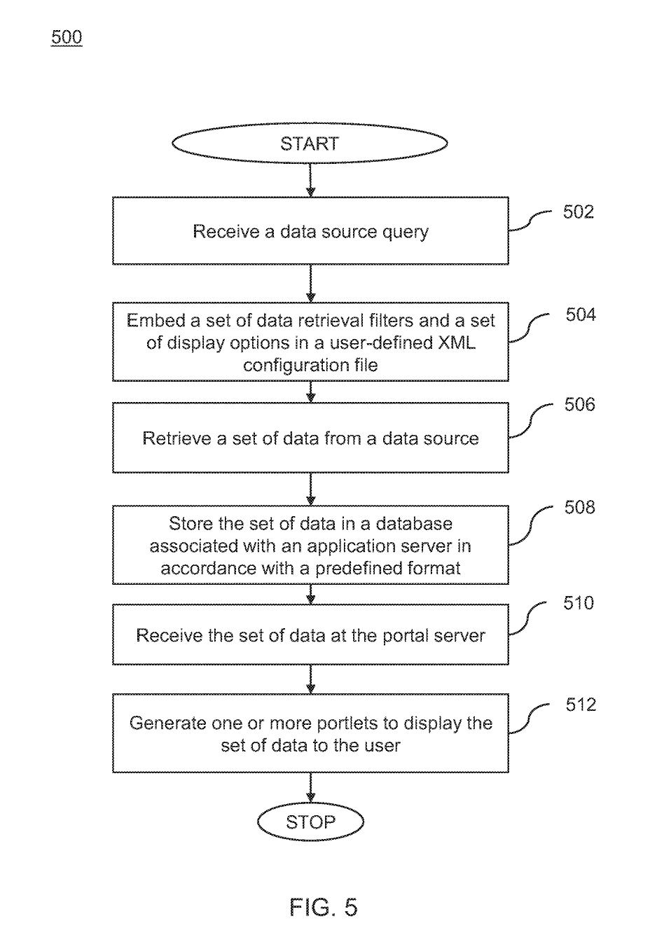

FIG. 5 is a flowchart of a method 500 for retrieving data from one or more data sources in accordance with the disclosed subject matter. Through the portal server 104, a data source query is received at step 502. The data source query can include, but is not limited to, connection information, data retrieval filters and/or display options. The data retrieval filters include one or more identities indicative of a data source from one or more data sources illustrated in FIG. 2 as data sources 210, 212 and/or 214. The display options can include, but are not limited to, at least one of a tabular layout, a chart layout, a news layout, a form layout, and a bullet layout.

At step 504, the retrieval filters and display options are embedded in the user-defined XML configuration file. The configuration file information further includes connection information which constitute any one or a combination of IP addresses, subnet masks, domain name server addresses, host name and suffix, execution parameters, system information pertaining to user and/or the portal server 104. At step 506, the application server 114, which is communicably coupled with the portal server 104, may retrieve a set of data from the data source based on the set of data retrieval filters embedded in the user-defined XML configuration file. At step 508, the retrieved data is stored in a predefined format in the information database 208 associated with the application server 114. The predefined format includes all of the display options specified in the user-defined XML configuration file.

At step 510, the portal server receives the set of data stored in the information database 208 and transmits the set of data to the user 108 through the DIP 204. At step 512, one or more portlets are generated by the portal server 104 to display the set of data in accordance with the set of display option and the predefined format. In some embodiments, the retrieved data is displayed on the user interface 300 at the results field 324. In some other embodiments, the generated portlet leads to a new web page showing the retrieved data. In alternate embodiments, the application server 114 may receive the data source query and the application 112 on the application server 114, selects the data source in accordance with the data source query and retrieves the set of data from the data source based on data retrieval filters specified in the user-defined XML configuration file.

As seen in FIG. 3, the form-based user interface 300 facilitates changes to be made to the data source query. Changes to the data source query include, but are not limited to, selecting a new data source or changing the retrieval filters. The changes form part of another query and are embedded in a separate user-defined XML configuration file.

### IV. Other Exemplary Embodiments

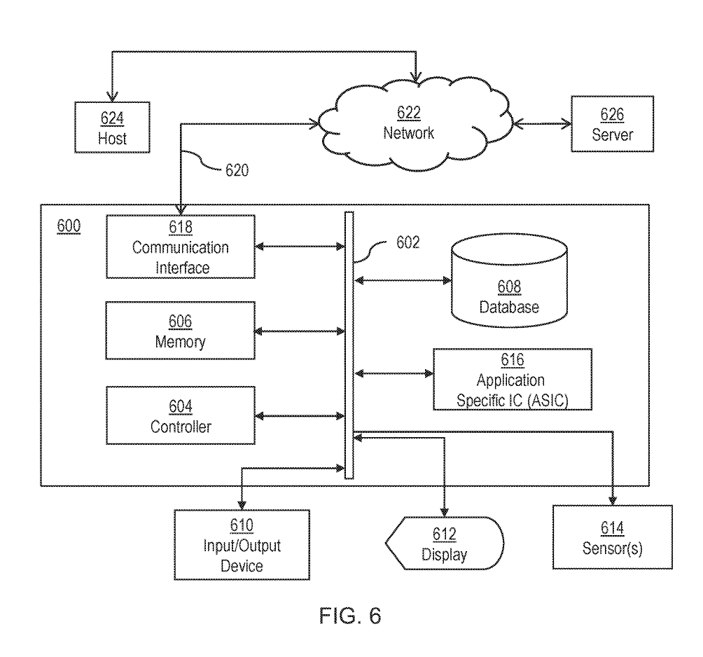

FIG. 6 illustrates a computer system 600 upon which the operation of the user 108, the DIP 204, the configuration file database 206, the information database 208, the portal server 104 and the application server 114 may be implemented. The application 112 may also be implemented by the computer system 600. Although, the computer system 600 is depicted with respect to a particular device or equipment, it is contemplated that other devices or equipment (e.g., network elements, servers, etc.) within FIG. 6 can deploy the illustrated hardware and components of system. The computer system 600 is programmed (e.g., via computer program code or instructions) to retrieve data from the data sources 102 described herein and includes a communication mechanism such as a bus 602 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. The computer system 600, or a portion thereof, constitutes a means for performing one or more steps retrieving data from one or more data sources 102.

A bus 602 includes one or more parallel conductors of information so that information is transferred quickly among devices coupled to the bus 602. A processor 604 for processing information are coupled with the bus 602.

The processor 604 performs a set of operations on information as specified by the user 108. The computer program code is a set of instructions or statements providing instructions for the operation of the processor 604 and/or the computer system 600 to perform specified functions. The code, for example, may be written in a computer programming language that is compiled into a native instruction set of the processor 604. The code may also be written directly using the native instruction set (e.g., machine language). The set of operations include bringing information in from the bus 602 and placing information on the bus 602. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 604, such as a sequence of operation codes, constitute processor instructions, also called computer system instructions or, simply, computer instructions. The processor 604 may be implemented as mechanical, electrical, magnetic, optical, chemical, or quantum components, among others, alone or in combination.

The computer system 600 also includes a memory 606 coupled to the bus 602. The memory 606, such as a Random Access Memory (RAM) or any other dynamic storage device, stores information including processor instructions for storing information and instructions to be executed by the processor 604. The dynamic memory 606 allows information stored therein to be changed by the computer system 600. RAM allows a unit of information stored at a location called a memory address to be stored and retrieved independently of information at neighboring addresses. The memory 606 is also used by the processor 604 to store temporary values during execution of processor instructions. The computer system 600 also includes a Read Only Memory (ROM) or any other static storage device coupled to the bus 602 for storing static information, including instructions, that is not changed by the computer system 600. Some memory is composed of volatile storage that loses the information stored thereon when power is lost. Also coupled to the bus 602 is a non-volatile (persistent) storage device 608, such as a magnetic disk, a solid state disk, optical disk or flash card, for storing information, including instructions, that persists even when the computer system 600 is turned off or otherwise loses power.

Information, including instructions for inspecting the XML data source query files is provided to the bus 602 for use by the controller 604 from an external input/output device 610. From an input perspective, the input/output device could include one or more elements such as a keyboard containing alphanumeric keys operated by a human user, a mouse, trackball, microphone, an Infrared (IR) remote control, a joystick, a game pad, a stylus pen, a touch screen, or any other of an input/output device. These devices can be capable of controlling a position of a small cursor image presented on the display 612 and issuing commands associated with graphical elements presented on the display 612.

From an output perspective, the input/output device 610 could include a Cathode Ray Tube (CRT), a Liquid Crystal Display (LCD), a Light Emitting Diode (LED) display, an organic LED (OLED) display, an active matrix display, an Electrophoretic Display (EPD), a plasma screen, or a printer for presenting text or images. Additionally, a separate display 612 may also include any of the previously mentioned devices or any other devices capable of visually, audibly, or even by means of touch, scent, etc. to provide output data to a user. Further, the display 612 may be a touch enabled display such as capacitive or resistive screen. In some embodiments, for example, in embodiments in which the computer system 600 performs all functions automatically without human input, one or more of the external input device 610, and the display 612 may be omitted.

Sensors 614 may be provided as components of the input/output device 610, or may be provided as independent components to the system 600. The sensor(s) 614 may detect conditions in its vicinity and transform those detections into physical expressions compatible with the measurable phenomenon used to represent information in the computer system 600 such as capturing, recording and causing to store one or more still and/or moving images (e.g., videos, movies, etc.) which also may comprise audio recordings. Sensors 614 may also detect elements such as motion, temperature, imagery or video, etc.

Other external devices can also be coupled to the bus 602 such as an Application Specific IC (ASIC) device 616. In the illustrated embodiment, special purpose hardware such as the ASIC 616 might serve as special purpose hardware configured to perform operations not performed by the controller 604 quickly enough for various purposes. Examples of ASICs include graphics accelerator cards for generating images for the display 612, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 600 also includes one or more instances of a communication interface 618 coupled to the bus 602. The communication interface 618 provides a one-way or two-way communication coupling to a variety of external devices that operate with their own processors, such as printers, scanners and external disks. In general, the coupling is with a network link 620 that is connected to a local network 622 to which a variety of external devices with their own processors are connected. For example, the communication interface 618 may be a parallel port or a serial port or a Universal Serial Bus (USB) port on a personal computer. In some embodiments, the communication interface 618 is an Integrated Services Digital Network (ISDN) card, a Digital Subscriber Line (DSL) card, or a telephone modem that provides an information communication connection to a corresponding type of a telephone line. In some embodiments, the communication interface 618 is a cable modem that converts signals on the bus 602 into signals for a communication connection over a coaxial cable or into optical signals for a communication connection over a fiber optic cable. As another example, the communications interface 618 may be a Local Area Network (LAN) card to provide a data communication connection to a compatible LAN, such as Ethernet™ or an Asynchronous Transfer Mode (ATM) network. In one embodiment, wireless links may also be implemented. For wireless links, the communication interface 618 sends or receives or both sends and receives electrical, acoustic or electromagnetic signals, including infrared and optical signals that carry information streams, such as digital data. For example, in wireless handheld devices, such as mobile telephones like cell phones, the communication interface 618 includes a radio band electromagnetic transmitter and receiver called a radio transceiver. In certain embodiments, the communication interface 618 enables connection to the communication network 106 for inspecting the user queries in the user-defined XML configuration files. Further, the communication interface 618 can include peripheral interface devices, such as a thunderbolt interface, a Personal Computer Memory Card International Association (PCMCIA) interface, etc. Although a single communication interface 618 is depicted, multiple communication interfaces can also be employed.

The term “computer-readable medium” as used herein refers to any medium that participates in providing information to the processor 604, including instructions for execution. Such a medium may take many forms, including, but not limited to, computer-readable storage medium (e.g., non-volatile media, volatile media), and transmission media. Non-transitory media, such as non-volatile media, include, for example, optical or magnetic disks, such as the storage device 608. Volatile media include, for example, the dynamic memory 606. Transmission media include, for example, twisted pair cables, coaxial cables, copper wire, fiber optic cables, and carrier waves that travel through space without wires or cables, such as acoustic waves, optical or electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a USB flash drive, a Blu-ray disk, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 616.

The network link 620 typically provides information communication using transmission media through one or more networks to other devices that use or process the information. For example, the network link 620 may provide a connection through the local network 622 to a host computer 624 or to ISP equipment operated by an Internet Service Provider (ISP).

A computer called a server host 626, connected to the Internet, hosts a process that provides a service in response to information received over the Internet. For example, the server 626 hosts a process that provides information representing video data for presentation at the display 612. It is contemplated that the components of the computer system 600 can be deployed in various configurations within other computer systems, e.g., the host 624 and the server 626.

At least some embodiments of the invention are related to the use of the computer system 600 for implementing some or all of the techniques described herein. According to one embodiment of the invention, those techniques are performed by the computer system 600 in response to the processor 604 executing one or more sequences of one or more processor instructions contained in the memory 606. Such instructions, also called computer instructions, software and program code, may be read into the memory 606 from another computer-readable medium such as the storage device 608 or the network link 620. Execution of the sequences of instructions contained in the memory 606 causes the processor 604 to perform one or more of the method steps described herein. In alternative embodiments, hardware, such as the ASIC 616, may be used in place of or in combination with software to implement the invention. Thus, embodiments of the invention are not limited to any specific combination of hardware and software, unless otherwise explicitly stated herein.

Various forms of computer readable media may be involved in carrying one or more sequence of instructions or data or both to the processor 604 for execution. For example, instructions and data may initially be carried on a magnetic disk of a remote computer such as the host 624. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 620. An infrared detector serving as the communication interface 618 receives the instructions and data carried in the infrared signal and places information representing the instructions and data onto the bus 602. The bus 602 carries the information to the memory 606 from which the processor 604 retrieves and executes the instructions using some of the data sent with the instructions. The instructions and data received in the memory 606 may optionally be stored on the storage device 608, either before or after execution by the processor 604.

### V. Alternative Embodiments

While certain embodiments of the invention are described above, and FIGS. 1 to 6 disclose the best mode for practicing the various inventive aspects, it should be understood that the invention can be embodied and configured in many different ways without departing from the spirit and scope of the invention.

For example, embodiments are disclosed above in the context of retrieving data from one or more data sources based on user queries embedded in a user-defined XML configuration files. However, embodiments are intended to include or otherwise cover any type of configuration file.

Embodiments as disclosed above allow retrieval of data from different data sources and display of the data as per user-defined display options and data retrieval filters through a portal server and an application server. Embodiments of the present disclosure further enable the portal server to be a single point of access in data retrieval and display without using any additional resources or applications on a user terminal.

Embodiments are also intended to cover storing retrieved data in any predefined format in a database associated with the portal server such that the data can be displayed through portlets generated by the portal server. The predefined format can be based on a type of data source and user-defined data fields provided in the user-defined XML configuration file.

Embodiments are also intended to cover any form building toolkit that allows creation of forms without coding for a portal page. The forms can be used to receive options from a user and display data.

Embodiments, as disclosed above, are directed to the system 100 that includes the application server 114 that handles multiple functions of the application 112. The portal server 104 provides a user-friendly interface for the input of data source queries. Options that form part of the data source query are populated in a form-based user interface 300 as shown in FIG. 3. The application server 114 provides computational resources that embed the data source query in the user-defined XML configuration file and further establish a link between the user 108, the portal server 104, the application 112.

Exemplary embodiments are intended to cover all software or computer programs capable of enabling processors to implement the above operations, designs and determinations. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary embodiments disclosed above.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or subnetworks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of a network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

While the subject matter has been described in detail with reference to exemplary embodiments thereof, it will be apparent to one skilled in the art that various changes can be made, and equivalents employed, without departing from the scope of the invention. All related art references discussed in the above Background section are hereby incorporated by reference in their entirety.

What is claimed is:

1. A method for exchanging data between a user and a data source, the method comprising:
configuring a non-transitory computer readable medium to access a set of data from the data source via a data source query in accordance with options specified in a user-defined XML configuration file, the user-defined XML configuration file further specifying a set of display options;
retrieving the set of data from the data source in accordance with data retrieval filters specified in the user-defined XML configuration file;
displaying the set of data in accordance with the set of display options specified in the user-defined XML configuration file; and
passing the data exchanged between the user and the data source through both an application server and a portal server.

2. The method of claim 1, wherein retrieving the set of data comprises:
receiving, at the application server, the data source query;
selecting, by the non-transitory computer readable medium, the data source in accordance with the data source query; and
retrieving, by the non-transitory computer readable medium, the set of data from the data source in accordance with data retrieval filters specified in the user-defined XML configuration file.

3. The method of claim 2, further comprises accessing, through the non-transitory computer readable medium, connection information stored in the user-defined XML configuration file to retrieve the set of data.

4. The method of claim 2, further comprises:
transforming, by the non-transitory computer readable medium, the set of data retrieved from the data source to a predefined format; and
storing the set of data transformed to the predefined format in a database associated with the application server.

5. The method of claim 4, further comprises:
receiving, at the portal server, the set of data stored in the database;
generating, by the portal server, one or more portlets on a portal page; and
displaying, through the one or more portlets, the transformed set of data in accordance with the set of display options specified in the user-defined XML configuration file.

6. The method of claim 1, wherein the non-transitory computer readable medium is a set of instructions stored on the application server.

7. The method of claim 1, wherein the application server is configured to be a platform for the portal server.

8. The method of claim 1, further comprising receiving the data source query from a portal page.

9. The method of claim 1, further comprising storing the user-defined XML configuration file in a memory local to the user.

10. The method of claim 1, wherein the data source query comprises one or more identities indicative of the data source, one or more sets of keywords, and the set of display options.

11. A method of retrieving data from a data source, the method comprising:
receiving, through a portal server, a data source query comprising a set of display options and a set of data retrieval filters, the set of display options and the set of data retrieval filters corresponding to the data source;
embedding the set of data retrieval filters and the set of display options into a user-defined XML configuration file;
retrieving, by an application server, a set of data from the data source in accordance with the set of data retrieval filters embedded in the user-defined XML configuration file, wherein the application server is communicably coupled with the portal server;
storing the set of data in a database associated with the application server in accordance with a predefined format;
receiving, at the portal server, the set of data stored in the database; and
generating, by the portal server, one or more portlets to display the set of data to the user in accordance with the set of display options and the predefined format.

12. The method of claim 11, wherein retrieving the set of data comprises:
receiving, at the application server, the data source query;
selecting, by an application on the application server, the data source in accordance with the data source query; and
retrieving, by the application, the set of data from the data source in accordance with data retrieval filters specified in the user-defined XML configuration file.

13. The method of claim 12, further comprises accessing, through the application, connection information stored in the user-defined XML configuration file to retrieve the set of data.

14. The method of claim 12, further comprises transforming, by the application, the set of data retrieved from the data source to the predefined format

15. The method of claim 11, further comprising storing the user-defined XML configuration file in a memory local to the user.

16. The method of claim 11, wherein the application server is configured to be a platform for the portal server.

17. A system for exchanging data between a user and a data source, the system comprising:
a portal that is configured to receive a data source query from the user, the data source query corresponding to the data source;
a processor that is configured to generate a user-defined XML configuration file based on the data source query, the user-defined XML configuration file including a set of display options and a set of data retrieval filters;
an application server communicably coupled to the portal, the application server configured to:
retrieve a set of data from the data source in accordance with the set of data retrieval filters specified in the user-defined XML configuration file; and
store the set of data in a database in accordance with a predefined format;
generating one or more portlets by a portal server communicably coupled to the portal and the application server; and
displaying the set of data through the portal in accordance with the set of display options and the predefined format.

18. The system of claim 17, wherein the application server is further configured to access connection information stored in the user-defined XML configuration file to retrieve the set of data.

19. The system of claim 17, wherein the portal server is further configured to receive the data source query from the portal and transmit the data source query to the application server.

20. The system of claim 17, wherein the processor is further configured to store the user-defined XML configuration file in a memory local to the user.
